(19) United States
(12) Patent Application Publication
(10) Pub. No.: US 2011/0046879 A1
(43) Pub. Date: Feb. 24, 2011

(54) Method and System for Presenting Information Associated With a Location

(75) Inventors: Massimiliano Celli, Romel (IT); Luigi Pichetti, Rome (IT); Marco Secchi, Rome (IT); Marcello Valati, Roma (IT)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/520,784

(22) PCT Filed: May 28, 2007
(86) PCT No.: PCT/EP07/55143

§ 371 Date: Jun. 22, 2009

(30) Foreign Application Priority Data
Dec. 21, 2006 (EP) 06126804.1

(51) Int. Cl. G01C 21/00

(52) U.S. Cl. 701/207; 701/200

(57) ABSTRACT

An enhanced navigation system in which present location is compared to a database of points of interest. Data for each point of interest include a reference to a source of dynamic information reflecting the real time status of the point of interest. Such a reference may comprise, for example, an Internet link. Real time status information will vary depending on the nature of the point of interest, and may include information such as whether the point is open or closed, queue lengths, waiting times, etc. The real time status information is retrieved from the source and presented to the user.

### FIELD OF THE INVENTION

The present invention relates to the provision of information based on geographic location, and more particularly to the presentation of real time status information associated with a particular location to a user.

### BACKGROUND OF THE INVENTION

Navigation systems such as those composed of a handheld device plus navigation SW, and a set of maps, are increasingly common, and offer the capability to visualize country or city maps, along with details of streets and major points of interest (POI).

If the navigation system is then equipped with a positioning system such as a portable GPS device connected to the navigation device, it becomes possible to display the “where am I” icon, and, given a pre-selected itinerary, is able to offer driving or walking directions.

Each POI instance is composed of specific latitude/longitude coordinates, and with “user consumable” information that are associated with it; such information, which gets displayed to the end user, is of a static nature, as it is part of the data which came with the POI data.

So, as one navigates toward a specific instance of a POI category (e.g., a specific Post Office among the “Post Office POI category”, or a specific Restaurant among the “Restaurant POI category”) the navigation SW is able to display, and eventually produce vocal advice, about static information of that POI, typically, name, address, telephone number, etc.

FIG. 1 shows an example of a prior art system. The area 100 represents the screen of a navigation device as described above, and shows a map built up of a road network 104 as well as other information pertinent to the user's journey 106. The user's present position and direction of travel are indicated by the chevron 101. The proposed route to the user's stated destination is shown by the shaded area 102. As shown, the map and route information are rendered in perspective. There is further shown a symbol 105, here representing a petrol pump, thereby suggesting a petrol station. This symbol represents a POI, as defined in a database stored in the navigation device. The user will generally have the option of selecting categories of POI for display on the screen. Additional information may conceivably be presented concerning individual POIs, depending on the content of the POI database.

Information available about the POI is defined in the POI database, and is as such necessarily static. In many cases information relevant to a particular POI and useful to the user is likely to be dynamic in nature, so that existing systems are unable to offer such broad and variable information to a user as may be desirable.

### SUMMARY OF THE INVENTION

According to the present invention, real time status information associated with a particular location is presented to a user. A location is determined for which associated real time status information is to be provided. An entry in a database of locations is identified as associated with the location. From the entry, a reference is extracted to a real time status information source. Real time status information is retrieved from the source and presented to the user.

Further advantages of the present invention will become clear to the skilled person upon examination of the drawings and detailed description. It is intended that any additional advantages be incorporated herein.

### BRIEF DESCRIPTION OF THE DRAWINGS

Embodiments of the present invention will now be described by way of example with reference to the accompanying drawings in which like references denote similar elements, and in which:

FIG. 1 shows an example of a prior art system;

FIG. 2a shows a first example of a display resulting from the first embodiment;

FIG. 2b shows a second example of a display resulting from the first embodiment;

FIG. 3 shows a sequence of steps realising the display of FIG. 2b;

FIG. 4 shows a further development of the method of FIG. 3; and

FIG. 5 shows a system implementing embodiments of the invention.

### DETAILED DESCRIPTION

As described above, information available from conventional systems does not reflect the real status of the POI itself, for instance the user cannot determine how many people are queuing up inside that specific post office, or the waiting time to be served in a selected restaurant. Having such information in advance, the user of the navigating device could take informed decisions before parking the car.

Accordingly there is provided an implementing system for allowing a navigation device and related software, to be able to dynamically introspect the internal status (e.g., internal traffic) of a POI, in order to offer real-time (vs. pre-recorded) info about a selected POI.

The proposed solution is based on an extension of the concept of “static” POI as described above by associating a logical “hyperlink” to it. Using such a link, the navigation device can then establish an RF connection to a specific service exposed from the POI instance dealer, to access to its internal status info.

To explain the proposed extension, we can take the current POI structure of one of the most popular pieces of navigation software, such as TomTom™; similar concepts however apply to different navigation implementation such as ViaMichelin, Microsoft AutoRoute, etc.

POIs are divided into categories, and each category is associated with an icon (for making easier selection, activation and display process) and with a binary file containing the instances belonging to the category. The binary file can be decompiled to obtain a textual file, which describes all instances; such file can be edited, corrected, augmented, and then recompiled.

A typical decompiled POI file is shown below:

```
; Readable locations in z:\Gigioexport.ov2
;
; Longitude, Latitude,  “Name”
; ========== ============
=======================================
  14.88287, 40.63793 , “Petrol Station Jim's motor's”
  14.86805, 40.64766 , “Petrol Station Fuel Stop”
  15.13510, 36.90985 , “Restaurant Bellevue
  15.11663, 36.74125 , “Hotel Journey's End”
```

The table shown is a 3 attribute table, where the first and second fields (Longitude and Latitude) are used from the navigation SW, to correctly place icons of active POI categories over the map being presented. The third field is an unformatted text line that is presented on user's screen, as the user approaches that POI instance, or when more info are requested on it.

Being unstructured, the “Name” field, can include a mixed set of info, like Name, Address, Telephone, etc.

While it may be possible to insert additional information into such an unformatted field, such as a weekday in which a Restaurant is closed, etc, such information would be limited to the pre-recorded entries which were originally inserted into the handheld device at the time that specific POI category was last downloaded. Furthermore, incorporating substantial details for a large proportion of POIs would have a disadvantageous impact on the size of the database storing POI data.

In any case, there would be no possibility to determine the internal status of the selected POI instance, i.e. the number of people queuing up in the lines, or expected wait time in a restaurant, next available film in a cinema which is not yet fully booked, a teller machine which is able to provide cash, etc.

To achieve such capability, according to this embodiment, the POI structure as described above is extended to host a link field to a web-service (or website) or other suitable data source offered from the POI dealer, which can provide additional internal information on demand.

```
; Readable locations in z:\Gigioexport.ov2
;
; Longitude, Latitude, “Name” “Link”
; ========== ============
====================================== =============
  14.88287, 40.63793 , “ Petrol Station Jim's motor's,
HTTP://WWW.jimsmotors.IT/LaNuovaMontecatini/POI.XML
  14.86805, 40.64766 , “ Petrol Station Fuel Stop,
HTTP://WWW.fuelstop.IT/LaRegina/POI.XML
  15.13510, 36.90985 , “ Restaurant Bellevue)” ,
HTTP://WWW.Bellevue/POI.XML
  15.11663, 36.74125 , “ Hotel Journey's End” ,
HTTP://WWW.Journeysend.IT/LaRegina/POI.XML
```

So, if the user navigating the map wants to know more details on a specific POI instance, he can select it on the map, and click on an offered hyperlink, for example.

Alternatively, the free text “name” field itself may be used to host the link field to a web-service (or website) or other suitable data source.

```
; Readable locations in z:\Gigioexport.ov2
;
; Longitude, Latitude, “Name”
; ========== ============
======================================
  14.88287, 40.63793 , “Petrol Station Jim's motor's <LINK: HTTP://WWW.
Jimsmotors.IT/LaNuovaMontecatini/POI.XML>/LINK>”
  14.86805, 40.64766 , “ Petrol Station Fuel Stop <LINK: HTTP://WWW.
Fuelstop.IT/LaRegina/POI.XML/LINK>”
  15.13510, 36.90985 , “Restaurant Bellevue <LINK:
HTTP://WWW.Bellevue/POI.XML/LINK>”
  15.11663, 36.74125 , “Hotel Journey's End <LINK:
HTTP://WWW.journeysend.IT/LaRegina/POI.XML/LINK>”
```

The link would activate an RF connection (typically using IP over GPRS or WiFi, against the IP declared in the link, typically a link to a WSDL document) from the navigation device to the information service exposed from the (POI instance) dealer.

In some cases, of the invention may use a more localized and inexpensive connectivity, like a Bluetooth one, if target POI is in the immediate proximity of the navigation device.

Each POI instance (a Restaurant, a Cinema, a PostOffice) which is interested in offering such status services to its potential customers, will have to expose the information it already shows to internal customers (the ones physically inside its building/hall), in an electronic format (e.g., html forms), over the internet by means for example of an url, and with standardized interface for example by means of a webservice.

The advantage for the user is that he can effectively stop himself by a specific POI instance, if the dynamic conditions satisfy his wills. The advantage for a dealer is to enhance customer satisfaction.

An extension to the described scenario can be the ability for the dealer to also publish specific information which only applies for the day (special exhibition in a Museum, special discounts inside a shop, Menu of the day for a Restaurant, etc.).

Another possible extension is to also offer booking and payment service over the established connection from the navigation device to the dealer, integrating services already offered over the Internet, into a navigation system experience.

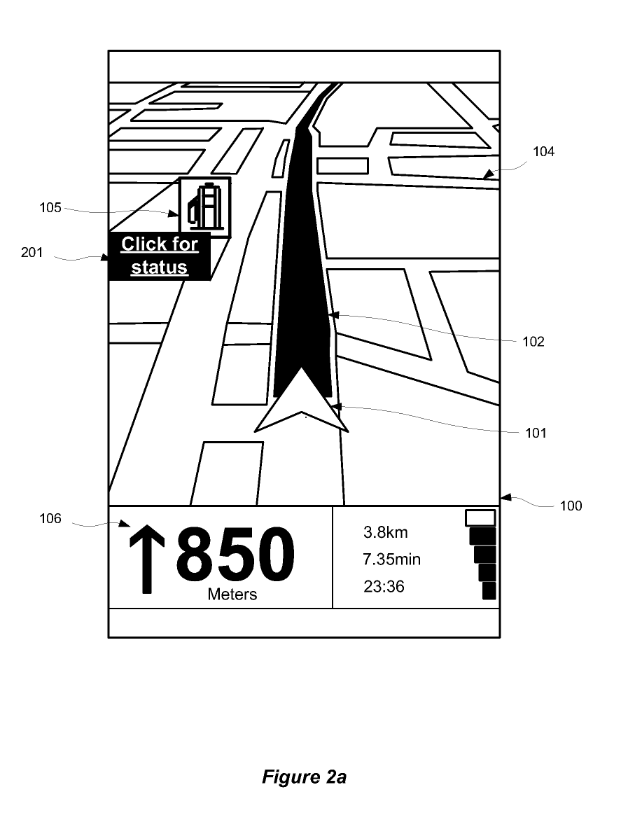

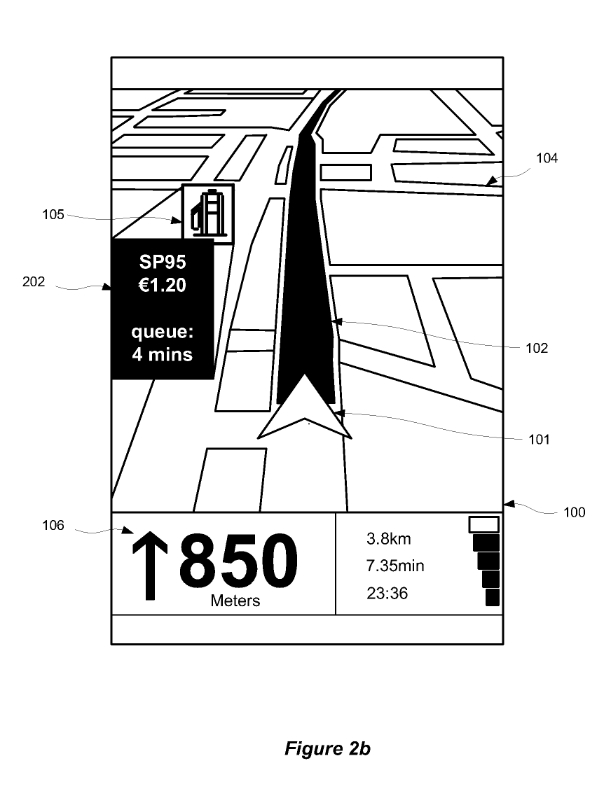

FIG. 2a shows a first example of a display resulting from the first embodiment. As shown in FIG. 2a the area 100 represents the screen of a navigation device as described above, and shows a map built up of a road network 104 as well as other information pertinent to the user's journey 106. The user's present position and direction of travel are indicated by the chevron 101. The proposed route to the users stated destination is shown by the shaded area 102. As shown, the map and route information are rendered in perspective. There is further shown a symbol 105, here representing a petrol pump, thereby suggesting a petrol station. This symbol represents a POI, as defined in a database stored in the navigation device. Here it will be seen that the symbol 105 is associated with a text box 201 which bears the message “click for status”, which according to certain embodiments as described hereafter may by clicked or otherwise selected by a user so as to request status information concerning the POI represented by the symbol 105.

FIG. 2b shows a second example of a display resulting from the first embodiment. As shown in FIG. 2b the area 100 represents the screen of a navigation device as described above, and shows a map built up of a road network 104 as well as other information pertinent to the user's journey 106. The user's present position and direction of travel are indicated by the chevron 101. The proposed route to the users stated destination is shown by the shaded area 102. As shown, the map and route information are rendered in perspective. There is further shown a symbol 105, here representing a petrol pump, thereby suggesting a petrol station. This symbol represents a POI, as defined in a database stored in the navigation device. Here it will be seen that the symbol 105 is associated with a text box 202 which contains information containing status information concerning the POI represented by the symbol 105. Specifically according to this example the text box 202 states the present price of petrol at that particular petrol station and the present queuing time.

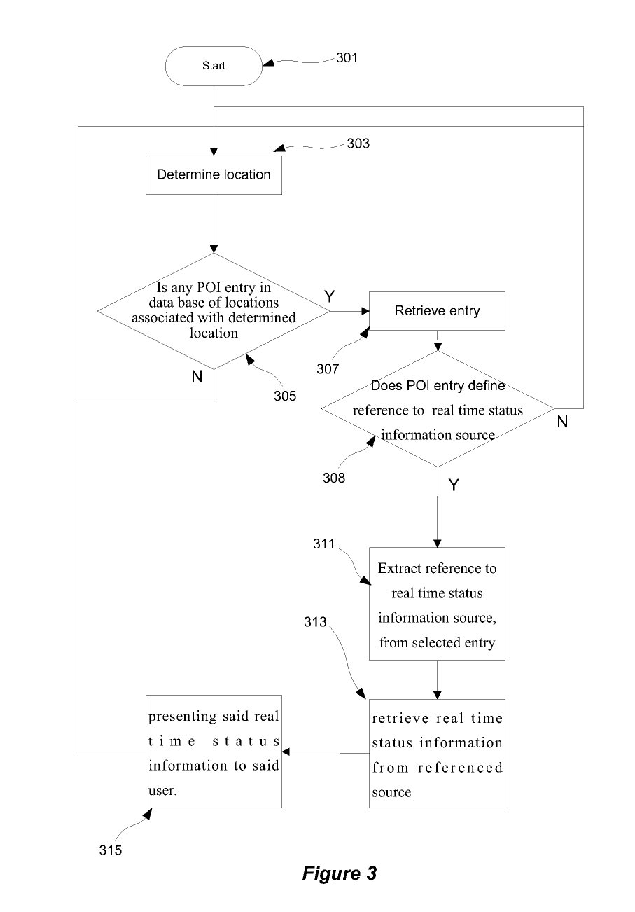

FIG. 3 shows a sequence of steps realising the display of FIG. 2b. As shown in FIG. 3, the method starts at step 301, and immediately proceeds to step 303 at which a location for which associated real time status information is to be provided is determined. The method next proceeds to step 305 at which a POI entry in a database of locations as associated with said location is identified. Where no such entry is identified the method returns to step 303. Otherwise, the method proceeds to step 307 at which the identified entry is retrieved from the database. At step 308, it is determined whether the identified POI entry contains a reference to a real time status information source. If no such reference is defined, the method may return to step 303. Otherwise, the method proceeds to step 311 at which the reference to a real time status information source is extracted from the entry. At step 313, the reference is used to retrieve the real time status information from said source, which can then be presented to the user at step 315 before returning to step 303.

The reference to real time status information may be an internet hyperlink, which offers the advantage of complying with a well known standard offering compliance with a vast existing infrastructure. POIs are often grouped by category. A wide range of categories can be envisaged, and may include by way of example Petrol stations, Mechanic, Accommodation, Restaurants, Museums, Tourist information offices. Categories may be arranged in a hierarchical manner. As the number of defined POIs grows, it is increasingly common to offer a user the option of displaying a subset of available POIs on the basis of selected categories or sub-categories. For example, a long distance driver may be interested in fast food outlets or petrol stations, but not museums or hospitals, and may make his POI selections accordingly.

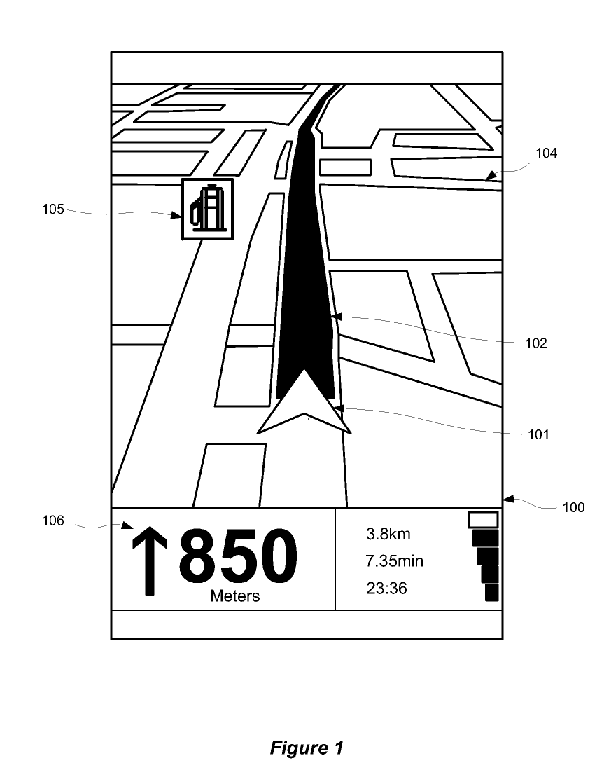

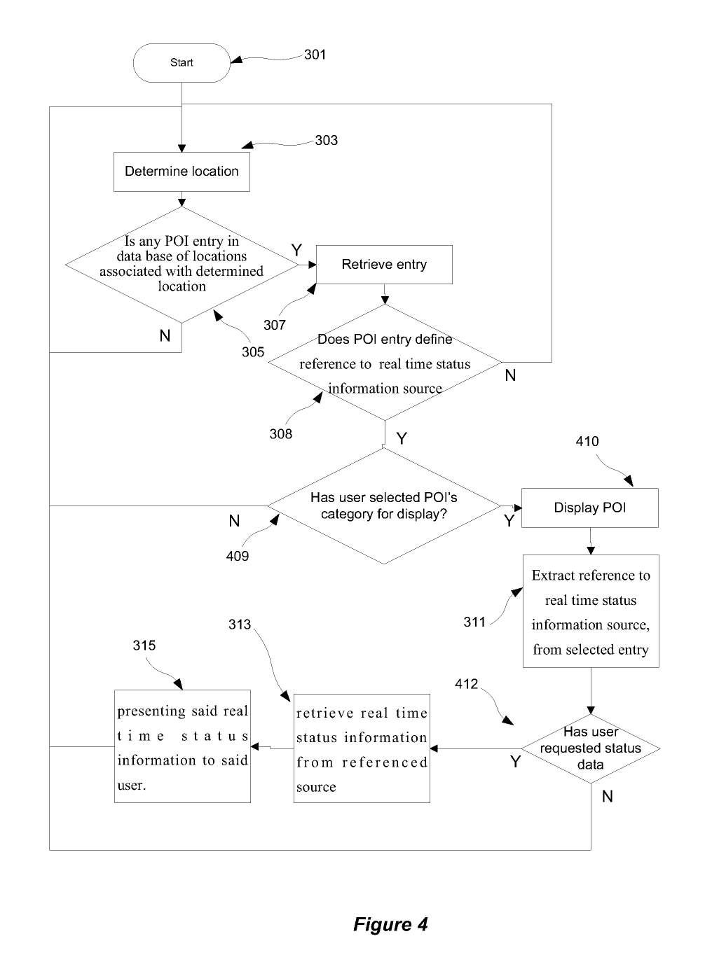

FIG. 4 shows a further development of the method of FIG. 3. As shown in FIG. 4, there is provided a further step 409 after step 308 of determining whether a user has selected the category of the entry identified at step 305 is one which the user has selected for display. Only where the identified entry is in fact determined to belong to a category selected for display does the method display the POI on the user interface display. Taking the example of FIGS. 1 and 2, the system determines the location indicated by the chevron 101 at step 303, and adjusts the map display accordingly. Furthermore with reference to the POI database, it is determined that the POI 105 is associated with the present location, e.g., that the POI 105 is sufficiently close to the location of chevron 101 that it should be displayed on the screen 100. It is furthermore determined at step 409 that the POI 105 belongs to the “petrol stations” category, which has in fact been selected by the user for display, so that the petrol station is duly added to the display 100 at step 410. The method then proceeds to step 311 as described above. A new step 412 is provided after step 311 at which it is determined whether the user has further more opted for the display of status data for displayed POIs, or for the category of POI in question. Only where it is determined that the user has opted for the display of status data for displayed POIs, or for the category of POI in question will the method proceed to the step 313 of retrieving the real time information. The user selection may be a matter of applying stored user preferences to the instantaneous situation, or alternatively require a specific action from the user, for example by clicking or otherwise selecting a region of the display 100 associated with the POI in question, for example clicking on the icon 105 itself or a nearby or area such as the area 201 as described above with reference to FIG. 2a. By default, such information may be obtained for all displayed POIs, but this is likely to lead to an excess of data on the screen. Aural or other means may of course be used in presenting the real time and other information to the user.

In the case where the method is employed in a driving situation such an aural approach may be preferable in view of the limited attention that a driver can safely afford the visual display of a navigation device.

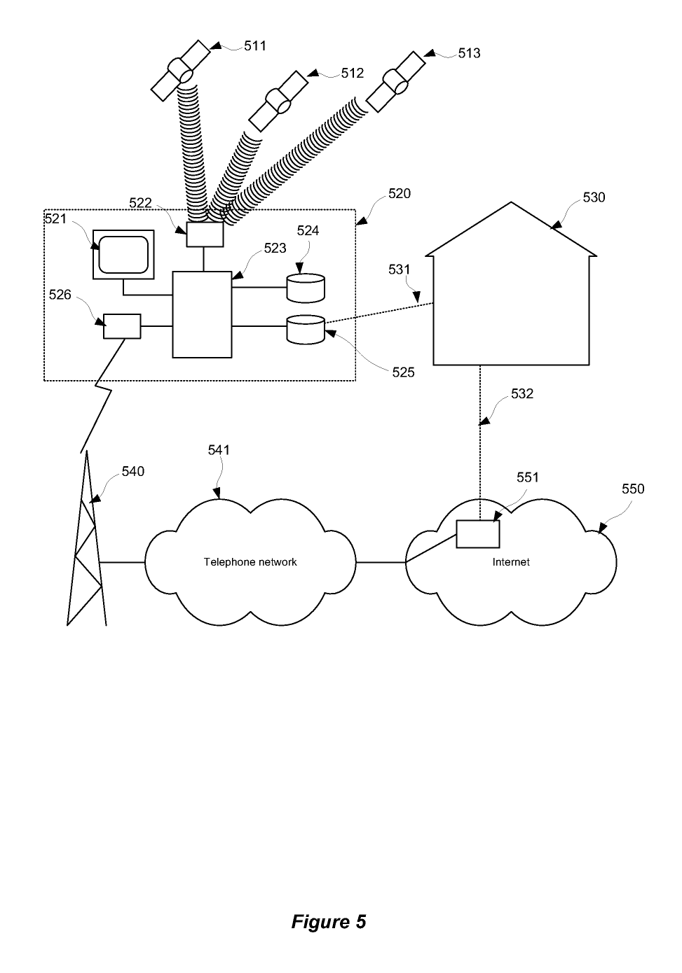

FIG. 5 shows a system implementing embodiments of the invention. As shown there is provided a device 520, which may be a portable computer, PDA (Personal Digital Assistant), mobile telephone, a custom built device or any other device having the necessary components as described hereafter. This device 520 comprises a user output means 521, a position transducer 522, a data retrieval interface 526, a mapping database 524 a point of interest database 525 and a processor 523. The device is apt to change location, and as such may be hand portable, or integrated or otherwise transportable in a vehicle.

By way of example, the user output means 521 comprises a display screen 100 as describe above, the position transducer 522 comprises a GPS antenna and processor receiving data from GPS satellites 511, 512, 513, and the data retrieval interface 526 is a digital air interface interfacing with a cellular telephone network 540, 541.

As shown in FIG. 5, there is further provided a physical location 530 which is here represented by a building. The physical location is associated with an internet site 551 as accessible by the internet 550. This association is represented by the dotted line 332. The physical location is furthermore associated with a POI defined In point of interest database 525 as indicated by the dotted line 531. In the context of the preceding examples the physical location 530 may be the petrol station associated with the POI 105.

The processor 523 is adapted to issue instructions to and receive data from the other parts of the system so as to implement the features described herein.

The POI entry in the database 525 defines a reference to the real time status information source, which as shown in FIG. 5 is embodied by the internet site 551, thus the reference itself comprises a URI, URL or similar so as to enable the device 520 to retrieve information from the relevant source by means for example of a digital data connection such as WAP, GPRS, UMTS etc over the Cellular connection 540, 541 to the internet 550

It will be appreciated that while the user output means 521 is described above in terms of a display screen, it may be implemented by any of a number of user interface means that will readily occur to the skilled person, such as audio means, or a combination of visual or audio means. Similarly the functions of the position transducer 522 may be realised by analysis of signals from different local cellular base stations, or using alternative satellite navigation systems such as the Gallileo system, or any other position determining system as will readily occur to the skilled person. In particular, where a cellular telephone transceiver is used to enable communications with the data source, a wide range of location technologies are known and in some case implemented by default in existing communications devices, which functionality would be ideally suited to use in this context. The data retrieval interface 526 may comprise any suitable means of requesting and receiving information.

The real time status information provided from the source 551 may take any form. It is an advantage of the approach described herein that the parties representing the interests of the physical location 530 are free to offer such information as they see fit on the source 551, and in any format they see fit. This approach is particularly attractive where the device 520 is a laptop computer or similar device offering a large display and sophisticated interface and control devices so that accessing the source 551 may lead to a prolonged browsing session, for example reading reviews of other users of the services in question, perusing a menu or undergoing a virtual tour, or simply following links to visit associated data sources. This approach is also most compatible with status data in the form of an actual image or video stream of the site in question, which may be appropriate or desirable in the context of certain POI categories. In many cases POIs may already be associated with Internet sites or similar which they can specify as their POI data source, thereby avoiding the need to prepare a special source for the purposes of the present invention.

Alternatively, it may be envisaged that the format of data may be to some extent limited for the purposes of the present invention. For example, standard formats for certain categories of POI may be defined so that real time status information for a particular type of POI is always presenting in the same way.

Such formats may be based for example on XML coding or similar for example. Here is one example of the form such a POI status definition file may take.

```
<?xml version=“1.0” encoding=“UTF-8”?>
<POIDEF name=“JIMS AUTOS” Category=“Petrol Station”>
  <FUEL PRICE=“1.2” unit=“ [symbol] /l”>SP95</FUEL PRICE >
  <QUEUE TIME=“4” unit=“mins”> SP95</ QUEUE TIME >
  <FUEL PRICE=“1.4” unit=“ [symbol] /l”>SP98</FUEL PRICE >
  <QUEUE TIME=“1” unit=“mins”> SP98</ QUEUE TIME >
</POIDEF>
```

RSS or Atom may also provide suitable means for providing such data. This approach offers advantages in that it facilitates the rapid assimilation of data by the user by presenting the same information on the same way for all similar POIs. It also makes possible a certain amount of intervention from the device itself possible, for example, it may also lead to a degree of language independence. For example, if the format presented above were used for all petrol station POIs, it would be possible for the device 520 to retrieve the information and to present it to the user in a contextual setting corresponding to the user's language and other preferences. Thus if one user had selected “UK” as his home country, and defined the petrol required by his vehicle as “SP95” he might be presented with:

### SP95 Price: 1.20/l (£0.80/l)

Queue time: 4 Minutes

Note that the device has automatically discarded the SP98 data. Also note that a pounds sterling equivalent has been calculated for the price of the petrol in Euros. The device may naturally take advantage of its connection to external data sources such as the internet 550 to obtain auxiliary real time information such as exchange rates, weather conditions etc which may assist in presenting useful POI data to the user.

If the user had selected “France” as his home country meanwhile, the same POI data from the same Internet site might be presented

### Prix SP95: 1.20/l

Temps d′attente: 4 Minutes

Since according to certain embodiments, the device 520 also implements navigation features, further synergies may be obtained from the fact that the device is in a position to estimate location values for the future. This may enable the device to estimate at what point in the future a user may begin to think about stopping for petrol, and look ahead to obtain information which may help the user make his choices advisedly. For example, if the device estimates that fuel will be required within the next 50 km, but determines by retrieving the relevant real time status data that the only petrol station along the route presently scheduled is closed, or charges an exorbitant rate, or does not offer the appropriate fuel, may suggest an alternative route to the user. Similarly, if the device determines that a meal time is approaching, and furthermore ascertains by retrieving the relevant real time status data that the restaurant at the next motorway services offers a special reduced rate for early diners, it may make a suggestion to the user appropriately.

Still further, the device 520 may be capable of communication with other devices. For example, it may be envisage that the device be equipped with means to interrogate the vehicle in which it may be mounted for vehicle status information. This may enable the device to monitor fuel levels so as to anticipate a need to look for petrol station POIs etc. Similarly, the device may look for signs of driver fatigue, and look for hotel or rest area POIs with vacancies, that would allow the driver to recover. Once again, the results of such determination may be fed back into navigation calculations so that a proposed route may be adapted to correspond to such anticipated requirements.

It will be appreciated that while the foregoing embodiments concern primarily the use of a navigation device in a vehicle, the invention extents equally to any device capable of presenting real time status information associated with a particular location to a user, by determining a location for which associated real time status information is to be provided, identifying an entry in a database of locations as associated with said location, extracting from said entry a reference to a real time status information source, retrieving real time status information from said source, and presenting said real time status information to said user. In particular, the determination of a location need not relate to determining a present poison by location means such as the GPS system etc, my may simply comprise selection of an arbitrary location, for example form a map. Similarly it will be appreciated that it is not necessary that a user be in any way involved with the selection of the location, or of a particular POI, or that any information concerning these selections be relayed to the user, but merely that the real time status information relevant to the location be presented to the user.

The term “point of interest” (POI) need not be interpreted as being limited to a single point or set of coordinates, but may equally comprise a larger space in or near which the user may find himself, such as a section of road, or even a geographic area, for example, which may be associated with particular weather details.

The term “real time” reflects the fact that the status information handled by the invention is generally inclined to be dynamic and to change over time to reflect the changes in status of the POI in question. In practice same delay between the change of status itself and the corresponding change of value of the status information may be expected.

Furthermore, it will be understood that while reference is made to a device implementing various activities, these devices may equally well be distributed among a number of devices. For example, a stand alone GPS or similar receiver may be accessed for example by means of a Bluetooth connection or cable. A mobile telephone with Bluetooth or other connectivity may provide the means to access the data source without necessarily offering other parts of the invention. The display 100 may form part of an in-vehicle entertainment system or the like and so on.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method of presenting real time status information associated with a particular location to a user, said method comprising
determining a location for which associated real time status information is to be provided;
identifying an entry in a database of locations as associated with said location;
extracting from said entry a reference to a real time status information source;
retrieving real time status information from said source; and
presenting said real time status information to said user.

2. The method of claim 1 wherein said location is the present location of the user.

3. The method of claim 1 wherein said location is a predicted future position of said user.

4. The method of claim 2 wherein identifying an entry in said database of locations as associated with said location involves determining whether said entry concerns a position physically proximate with said location.

5. The method of claim 3 wherein considering of whether said entry concerns a position physically proximate with said location comprises determining whether said position is within a predetermined distance of said location.

6. The method of claim 1 wherein said reference to a real time status information source is an Internet address, and wherein said step of retrieving real time status information from said source involves interrogating the internet server identified by said internet address.

7. A computer program product in a computer storage medium comprising instructions for carrying out the steps of a method when said computer program product is executed on a computer, the method comprising:
determining a location for which associated real time status information is to be provided;
identifying an entry in a database of locations as associated with said location;
extracting from said entry a reference to a real time status information source;
retrieving real time status information from said source; and
presenting said real time status information to said user.

8. The product of claim 7 wherein identifying an entry in said database of locations as associated with said location involves determining whether said entry concerns a position physically proximate with said location.

9. A system comprising:
a processor;
a memory for containing instructions and data which when executed by the processor perform the method comprising:
determining a location for which associated real time status information is to be provided;
identifying an entry in a database of locations as associated with said location;
extracting from said entry a reference to a real time status information source;
retrieving real time status information from said source; and
presenting said real time status information to said user.

10. The system of claim 9 further comprising a GPS receiver for determining the location.
